(19) United States
(12) Patent Application Publication
(10) Pub. No.: US 2005/0193287 A1
(43) Pub. Date: Sep. 1, 2005

(54) Data accessing method

(75) Inventors: Dae-Ning Guo, Taipei (TW); Ching-Yu Chen, Taipei (TW); Meng-Huang Chu, Taipei (TW); Pei-Jei Hu, Taipei (TW)

Correspondence Address: TROXELL LAW OFFICE PLLC;SUITE 1404, 5205 LEESBURG PIKE, FALLS CHURCH, VA, 22041, US

(73) Assignee: VIA TECHNOLOGIES, INC.

(21) Appl. No.: 10/774,441

(22) Filed: Feb. 10, 2004

(51) Int. Cl. G06F 11/00

(52) U.S. Cl. 714/52

(57) ABSTRACT

A method for accessing data from a storage medium according to requirements of a host is disclosed. The storage medium stores a plurality of data blocks that each one of them further includes a plurality of data sectors and an error correction code used for recovering errors of the data block. Each one of the data sectors further includes an error detection code used for detecting correctness of associated data sector. When a data block is verified to include at least one incorrect data sectors by means of the error detection codes, those correct data sectors rather than all the data sectors are stored into a specific position of a data buffer. The whole data block is next re-fetched and stored into the same position of the data buffer used to occupied by the data block, those stored correct data sectors are then re-fetched to overwrite corresponding ones in the data buffer. Thereafter, the incorrect data sectors are re-detected to verify their correctness again. Not only those correct data sectors will be faultless protected, but also upgrade data access performance.

### BACKGROUND OF THE INVENTION

(a). Field of the Invention

The present invention relates in general to data accessing of a storage medium, and more particularly to a data accessing method in an optical electronic system that employs part of data verified as correct to overwrite the corresponding part of the re-fetched data, thereby upgrading the data accuracy.

(b). Description of the Prior Arts

Optical disc storage devices are among the most popular computer peripherals in recent years, and their technologies and associated specifications are making progress continuously. The digital video disc (DVD) as a new mainstream specification of optical disc storage is overwhelming and its application is getting more and more popular. Following the massive requirement to upgrade the accessing rate of DVD, it becomes a very important issue to simultaneously improve the accuracy of data accessing and secure an ideal cost/performance (C/P) ratio.

A brief description about the data format of DVD is provided below. First, a DVD data sector is composed of 2064 bytes, and its format is shown as FIG. 1. In FIG. 1, the DVD data sector includes 12 rows, and each row is 172 bytes long. The data sector includes in turn 4 bytes of ID, 2 bytes of ID Error Detection (IED) code, 6 bytes of Copyright Management Information (CPR_MAI), 2048 bytes of main data (D₀-D₂₀₄₇), and 4 bytes of Error Detection Code (EDC). Wherein, the EDC is encoded in the form of Cyclic Redundancy Check (CRC) and used to detect the correctness of the data sector.

Second, in order to provide better data protection, a DVD data block is composed of 16 data sectors encoded in the form of Reed Solomon Product Code (RSPC), as shown in FIG. 2. In FIG. 2, the DVD data block contains 16 sectors, which total 192 (=12×16) rows and 172 columns, and the outer-code parity (PO) and inner-code parity (PI) data generated by the RSPC encoding. The PO data is generated column by column and 16 bytes long for each column, while the PI data is generated row by row and 10 bytes long for each of the 208 rows (including the 16 rows of PO data). Here the whole data block is processed as an error correction code (ECC) block, and the PO and PI data is the ECC for recovering data errors.

The conventional DVD technology employs the architecture of FIG. 3 to access data from a DVD disc. In FIG. 3, the data on a DVD disc 310 is fetched by a pick-up head 311 and transformed into row data 315 by an analog signal processor 312 and an EFMPLUS demodulator 314. The row data 315 is then stored into a memory 321 via a row data interface 316 by a memory controller 320. When the data stored in the memory 321 can form an ECC data block, a RSPC decoder 317 accesses the data block in the memory 321 by means of the memory controller 320, and decodes the PO and PI data therein to recover data errors. Next, an EDC processor 318 reads the data sectors in the data block and calculates the EDC of each data sector. If all the EDCs are correct, the main data of the data sectors are transferred to a host 322 via a host interface 319. Therefore, in the process of accessing a DVD data block, the PO and PI data corresponding to the data block are first decoded and corrected, and then the EDC of each data sector is verified to assure the correctness of the accessed data.

If any one of the 16 EDCs is incorrect, two common methods are applied. The first one re-performs the whole decoding and verification on the original accessed data block until all the EDCs are correct. The second one re-fetches the data block from the DVD disc, and decodes and verifies the re-fetched block. If there still is any incorrect data sector, the whole process (including re-fetching the block) is repeated until all the EDCs are correct. The above conventional methods have two main drawbacks: one is that the accessing frequency of the memory 321 is too high; the other is that re-fetching or re-decoding of the whole data block is needed to recover the data errors. These drawbacks would impact the DVD data-accessing rate and performance seriously.

R.O.C. Patent No. 88121259, entitled “DVD Data-Accessing Apparatus and Method”, provides some improvements for the above issues. Please refer to FIG. 4, which is the block diagram showing the improved apparatus of the patent. First, the improved apparatus decodes the PI data and generates the EDC of each data sector by means of a row data interface and first PI decoder 416, an EDC generator 417 and a row data buffer 418. The row data 415 is then stored into a memory 421. In this way, the load of memory accessing, resulted from the PI decoding and EDC calculation of the conventional technology, can be mitigated. Second, by means of the design of an EDC file 422, an EDC processor 424 and a RSPC decoder 426, the apparatus modifies the previously generated EDCs by using the error correction results at the same time as decoding the PO data and recovering errors. Last, if all the EDCs are correct, then the accessed data is transferred to a host 430 via a host interface 428. Besides, this patent also provides a data accessing method for re-reading a data block if all the EDCs therein are not correct. This method can skip the data sectors verified as correct when re-reading the data block, thereby improving the data-accessing efficiency.

However, the architecture of FIG. 4 needs extra hardware and complex circuits to achieve these improvements. Thus, the chip design is much more difficult, and the chip area and cost are also increased significantly. In view of this, the present invention provides a data accessing method that can modify data errors and upgrade the performance of data correction by using the simpler architecture of FIG. 3 along with appropriate firmware programs.

### SUMMARY OF THE INVENTION

The objective of the present invention is to provide a method for accessing data from a storage medium according to requirements of a host. In a preferred embodiment, the storage medium stores a plurality of data blocks, and each of the data blocks includes a plurality of data sectors and an error correction code (ECC) for recovering errors of the corresponding data block. Each of the data sectors includes an error detection code (EDC) for detecting correctness of the corresponding data sector. According to the preferred embodiment, the method uses a specific memory block to store the correct data sectors of a fetched data block. If the fetched data block contains any incorrect data sector and needs re-fetching, the method overwrites the corresponding data sectors with the previously stored correct ones. In this manner, the data sectors previously verified as correct can be protected to upgrade the data accessing accuracy. Moreover, the preferred embodiment can be implemented by using the conventional hardware architecture along with appropriate firmware programs. Thus, no extra hardware design is needed and manufacturing cost can also be saved.

### BRIEF DESCRIPTION OF THE DRAWINGS

FIG. 1 is a diagram depicting the format of a DVD data sector.

FIG. 2 is a diagram depicting the format of a DVD data block.

FIG. 3 is a block diagram of a conventional data accessing architecture.

FIG. 4 is a block diagram of an improved data accessing architecture.

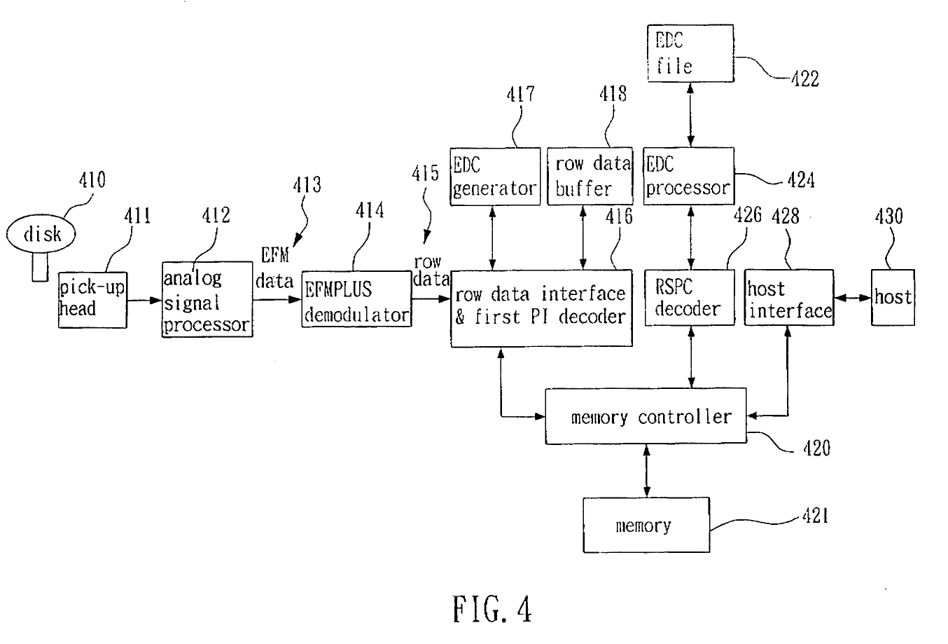

FIG. 5 is a flow chart of the method for recovering DVD data accessing errors according to a preferred embodiment of the present invention.

### DETAILED DESCRIPTION OF THE PRESENT INVENTION

This section will provide a detailed description with a preferred embodiment and appended drawings to better understand the goals and features of the present invention. The preferred embodiment relates to DVD. However, the present invention is not limited to the DVD embodiment. If a storage medium stores multiple data blocks, each includes multiple data sectors and an ECC for recovering errors, and also if each data sector includes an EDC for detecting correctness of the corresponding one, then the present invention can upgrade the data accessing accuracy and performance.

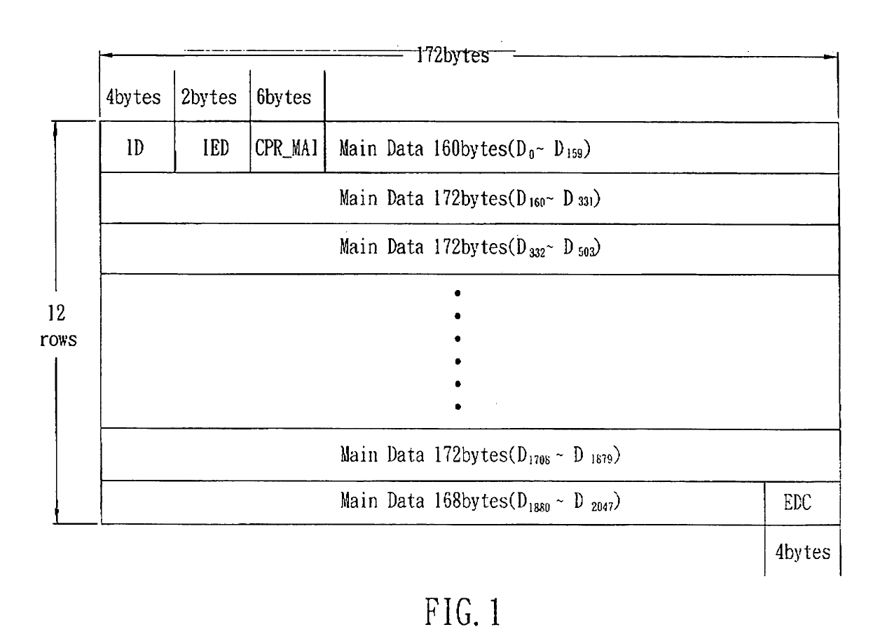

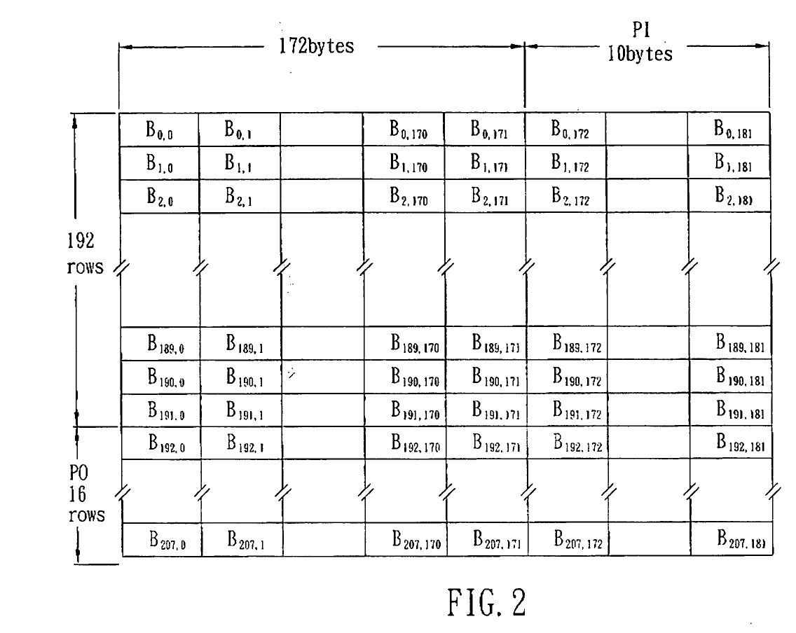

As mentioned above, a DVD data sector is composed of 2064 bytes in the format of FIG. 1, where a 4-byte EDC is included for detecting correctness of the DVD data sector. Furthermore, an ECC data block is composed of 16 DVD data sectors along with the RSPC-encoded data, as shown in FIG. 2, where the RSPC-encoded data (PI & PO) is used to recover data errors. Therefore, the method of the present invention can be applied to correct the data errors generated when accessing a DVD disc.

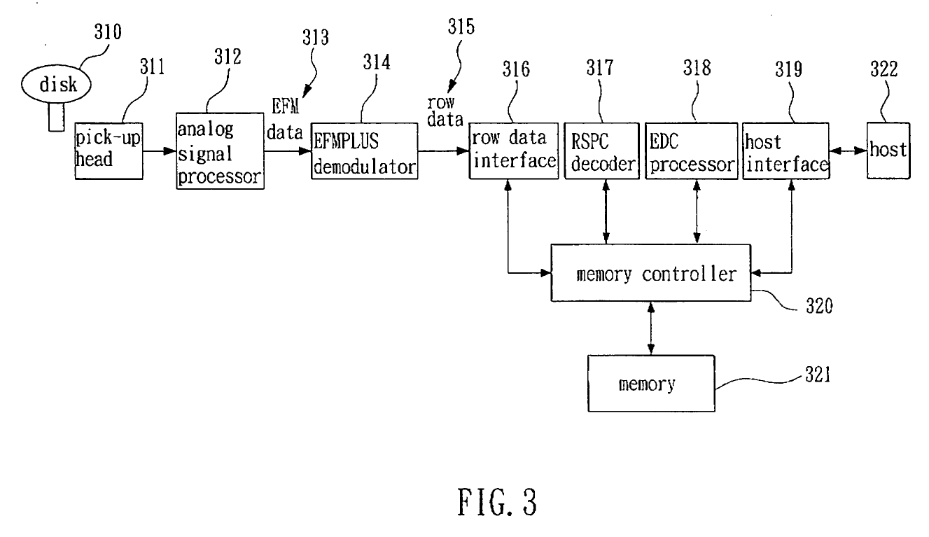

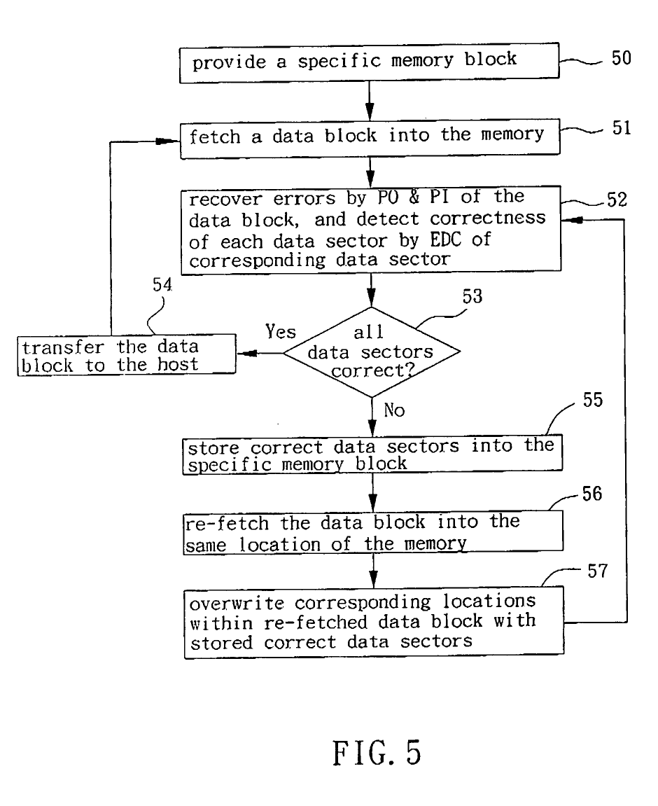

FIG. 5 is a flow chart of the method for recovering DVD data accessing errors according to the preferred embodiment of the present invention. As shown in FIG. 5, the method performs the following steps under the architecture of FIG. 3:
50 providing a specific memory block in the memory 321;
51 fetching a data block from the disc 310 into the memory 321;
52 recovering errors by using the PO and PI data of the data block, and detecting correctness of each data sector within the block by using the EDC of the corresponding data sector;
53 determining whether all the data sectors are correct;
54 transferring the data block to the host 322 and returning to the step 51 if all the data sectors are correct;
55 storing correct data sectors into the specific memory block;
56 re-fetching the data block into the same location of the memory 321; and
57 overwriting the corresponding locations within the re-fetched data block with the stored correct data sectors and returning to the step 52.

It is notable that since the correct data sectors are written to the memory 321 in the step 57, these correct sectors can be skipped after returning to the step 52 (no matter whether the EDCs of these sectors in the re-fetched data block are correct or not). Thus, the data processing can be focused in incorrect data sectors, and processing time can also be shortened. Moreover, the above steps can be implemented as a corresponding firmware program and then executed in the hardware architecture of FIG. 3. There is no need to add extra hardware components (e.g. the EDC file 422) for implementation. Besides, the present invention can be applied to the optical electronic system with data-accessing capability, such as CD-ROM drive, DVD-ROM drive, DVD player, DVD±RW drives, etc., to assure the data accuracy. The “specific memory block” in the preferred embodiment may be any block in the memory 321, as long as the content of the block would not be altered by any other programs. Also, the contents of the firmware program mentioned above can be modified for practical purposes, and one skilled in the art can make modifications according to his requirements.

While the present invention has been shown and described with reference to two preferred embodiments thereof, and in terms of the illustrative drawings, it should be not considered as limited thereby. Various possible modification, omission, and alterations could be conceived of by one skilled in the art to the form and the content of any particular embodiment, without departing from the scope and the spirit of the present invention.

1. A method for accessing data from a storage medium according to requirements of a host, the storage medium storing a plurality of data blocks, wherein each of the data blocks comprises a plurality of data sectors and an error correction code (ECC) for recovering errors of the each of the data blocks, and each of the data sectors comprises an error detection code (EDC) for detecting correctness of the each of the data sectors, the method comprising steps of:
fetching a data block from the data blocks of the storage medium;
recovering errors of the data block by the ECC of the data block;
detecting correctness of each data sector of the data block by the EDC of the each data sector of the data block; and
performing following sub-steps when at least one incorrect data sector is detected:
storing correct data sectors of the data block;
re-fetching the data block from the storage medium;
overwriting corresponding locations of the re-fetched data block with the stored correct data sectors; and
re-performing the recovering step and the detecting step to ensure correctness of all the data sectors.

2. The method of claim 1, wherein the storage medium is accessed by one of a CD-ROM drive, a DVD-ROM drive, a DVD player and a DVD±RW drive.

3. The method of claim 1, wherein the ECC comprises outer-code parity (PO) data and inner-code parity (PI) data encoded in a form of Reed Solomon Product Code (RSPC).

4. The method of claim 1, further comprising:
transferring the data block to the host when all the data sectors of the data block are correct.

5. The method of claim 1, wherein the re-fetching step comprises re-fetching the data block to store the re-fetched data block into a same location of a memory occupied by the previously fetched data block.

6. The method of claim 6, wherein the storing sub-step comprises storing the correct data sectors in a specific memory block having a location different with that of the data block is stored.

7. A method for assuring data correctness in an optical electronic system, comprising steps of:
fetching a data block, wherein the data block comprises a plurality of data sectors, and at least one of the data sectors is incorrect;
storing correct ones of the data sectors in a specific memory block;
re-fetching the data block; and
overwriting corresponding locations of the re-fetched data block with the stored correct data sectors.

8. The method of claim 7, further comprising a procedure for detecting correctness of the data sectors, wherein the procedure comprises:
recovering errors of the data block by an error correction code (ECC) of the data block; and
detecting correctness of each of the data sectors by the error detection code (EDC) of the each of the data sectors.

9. The method of claim 8, further comprising:
repeatedly performing the procedure, the storing step, the re-fetching step and the overwriting step until all the data sectors are correct.

10. The method of claim 9, further comprising:
transferring the data block to a host coupled to the optical electronic system when all the data sectors are correct.

11. The method of claim 7, wherein the optical electronic system comprises one of a CD-ROM drive, a DVD-ROM drive, a DVD player and a DVD±RW drive.

12. The method of claim 7, wherein the re-fetching step comprises re-fetching the data block to store the re-fetched data block into a same location of a memory occupied by the previously fetched data block.

13. The method of claim 12, wherein the specific memory block has a location different with that of the data block is stored within the memory.

14. A method for assuring data correctness in an optical electronic system, comprising steps of:
fetching a data block from an optical medium to store the data block in a first memory block, wherein the data block comprises a plurality of data sectors, and at least one of the data sectors is incorrect;
storing correct ones of the data sectors in a second memory block;
re-fetching the data block to overwrite a same location occupied by the previously fetched data block; and
overwriting corresponding locations of the re-fetched data block with the correct data sectors stored in the second memory block.

15. The method of claim 14, further comprising:
transferring the data block to a host coupled to the optical electronic system when all the data sectors are correct.

16. The method of claim 14, further comprising a procedure for detecting correctness of the data sectors, wherein the procedure comprises:
recovering errors of the data block by an error correction code (ECC) of the data block; and
detecting correctness of each of the data sectors by the error detection code (EDC) of the each of the data sectors.

17. The method of claim 16, wherein the re-fetching step, the overwriting step, the procedure are repeated until all the data sectors of the data block are correct.

18. The method of claim 14, wherein the optical electronic system comprises one of a CD-ROM drive, a DVD-ROM drive, a DVD player and a DVD±RW drive.

19. The method of claim 14, wherein the first memory block has a location different with that of the second memory block within a memory of the optical electronic system.
